(19) United States
(12) Patent Application Publication
(10) Pub. No.: US 2012/0316774 A1
(43) Pub. Date: Dec. 13, 2012

(54) AUTOMATIC NAVIGATION TO A PRIOR KNOWN LOCATION

(75) Inventors: Eran Yariv, Zichron Yaakov (IL); Yair E. Geva, Zichron Yaakov (IL); Fadi Haik, Shafaram (IL)

(73) Assignee: MICROSOFT CORPORATION, Redmond, WA (US)

(21) Appl. No.: 13/156,365

(22) Filed: Jun. 9, 2011

(51) Int. Cl. G01C 21/00

(52) U.S. Cl. 701/423; 701/426

(57) ABSTRACT

The disclosed architecture facilitates the capture of data associated with a specific geographic location, as captured by a mobile device of a user at the geographic location, for the purpose of guiding the user back to that specific geographic location. When applied to vehicles or other types of user mobility (e.g., walking) the architecture automatically detects that a user has controlled a means of transportation to a stationary (or parked) state, such as associated with a parked car. When the stationary state is reached, the location is detected (e.g., using user device sensing systems). Detection can include recording images, sounds, speech, geolocation data, etc., associated with the location and/or means of transportation. The user can configure a reminder to activate at the location to assist in the user recalling the location when returning to the means of transportation.

### BACKGROUND

In the highly mobile world, people are constantly on the move with activities such as shopping, commuting back and forth to work, taking children to school, and otherwise, performing a wide variety of activities. In these scenarios, the locations associated with these activities are usually well-known after some amount of repetitive navigation to the location.

However, it is also the case where the activities involve navigating back to a prior location with which a person is familiar or simply fails to recall such as during travel, vacations, a shopping activity to a new area, and so on.

Consider, for example, that in large parking lots users oftentimes forget where their car is parked. Existing solutions rely on the user to be proactive when leaving the car in order to remember where the car is parked. However, this approach does not solve the case were the user forgets to be proactive. In other situations, the user wants to set a reminder for an action that needs to be performed when the user leaves a vehicle, such as a reminder to take something from the car. Again, the user needs to take a proactive action to accomplish this. Thus, the inability to navigate back to prior known locations can be a seminal problem.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture facilitates the capture of data associated with a specific geographic location, as captured by a mobile device of a user at the geographic location, for the purpose of guiding the user back to that specific geographic location. The mobile device (e.g., a cellular telephone) detects parameters such as geolocation information (coordinates), camera (for images and video), audio information (using a microphone), directional (e.g., accelerometer data as the device moves), user speech input, and so on. The parameters represent attributes of the geographic location such as related to sound, geographic coordinates, surrounding scenes (images), relationship to other notable landmarks, and so on. A presentation component of the user mobile device enables viewing of the specific geographic location as presented graphically relative to a virtual geographical map in which the specific geographic location resides and facilitates navigation back to the specific geographic location.

The architecture finds particular applicability to guiding a user back to a prior parking location. The architecture can automatically detect that a user has controlled a means of transportation to a stationary (or parked) state, such as associated with a parked car, and the location. When the stationary state is reached, the location is detected using sensing systems of an associated user device (e.g., a mobile phone). Detection can include recording images, sounds, speech, geolocation data, etc., associated with the location and/or means of transportation.

The architecture can comprise a notification component that enables the user of the user device to initiate self-notification (reminder) to facilitate recall of the location when returning to the means of transportation. The detection capabilities can include an application that automatically runs on the user device.

A management component is employed for determining which parameters (detectors and actions) are relevant and selected for the means of transportation, for a given location, and settings for the selected parameters. The management component enables the user to define and configure the detectors that are relevant such as configuring the noise (e.g., parking) relevant for the means of transportation, and the actions that are to be performed when the means of transportation is in the parked state. This includes setting reminders that are to be displayed. To assist the user in returning to the location, a presentation component presents the location on a map the represents the geographical information.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates a system that enables guidance back to a prior known parking location in accordance with the disclosed architecture.

FIG. 3 illustrates an exemplary system for location of a means of transportation or a stop location.

FIG. 4 illustrates an exemplary system where the user device includes the presentation component, detection component, notification component, and management component.

FIG. 5 illustrates a method in accordance with the disclosed architecture.

FIG. 6 illustrates further aspects of the method of FIG. 5.

FIG. 7 illustrates an alternative method in accordance with the disclosed architecture.

FIG. 8 illustrates further aspects of the method of FIG. 7.

FIG. 9 illustrates a block diagram of a computing system that executes location architecture in accordance with the disclosed architecture.

### DETAILED DESCRIPTION

The disclosed architecture facilitates the navigation of a user back to a prior known location such as a parking spot or other specific geographic location. A mobile device such as a cellular telephone can be utilized to detect and select parameters for identifying the prior location, such as geolocation information (coordinates), camera settings (for images and video), audio setting (using a microphone), directional setting (e.g., accelerometer data as the device moves), user speech input settings, and so on. The parameters are associated with capturing data related to attributes of the geographic location such as sound, geographic coordinates, surrounding scenes, relationship to other notable landmarks, and so on.

The user is guided back to the prior location via presentation of the specific geographic location relative to a virtual geographical map in which the specific geographic location resides. Alternatively, or in combination therewith, guidance or navigation can be by text, the map, auto-generated voice signals, or a combination of any of the previous such as the text and map that directs the user back to the specific geographic location.

In one implementation described in detail, the architecture automatically detects that a user has controlled a means of transportation to a stationary (or parked) state, such as associated with a parked car. When the stationary state is reached, the location is detected (e.g., using user device sensing systems). Detection can include recording images, sounds, speech, etc., associated with the location and/or means of transportation. The user can configure a reminder to activate at the location to assist the user in taking an action that facilitates recall of the location when returning to the means of transportation.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

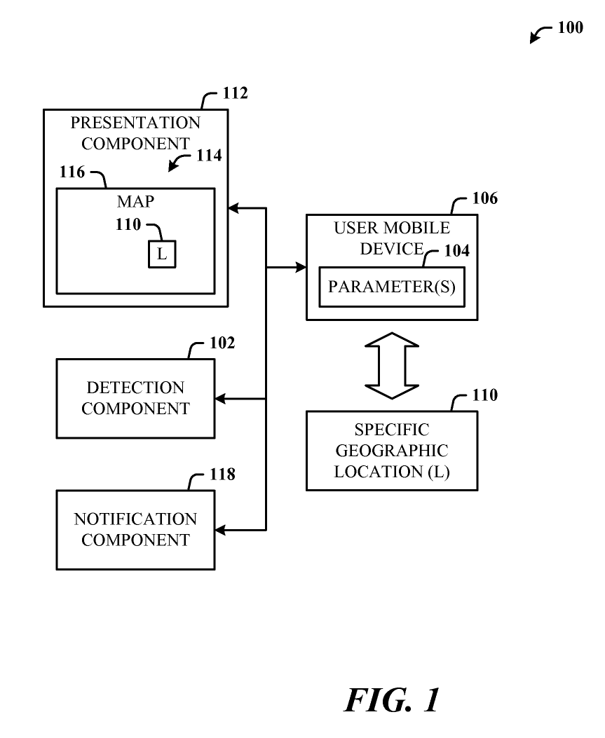

FIG. 1 illustrates a system 100 in accordance with the disclosed architecture. The system 100 includes a detection component 102 (e.g., of a user device 106) that detects parameters 104 associated with a specific geographic location (also denoted L) 110 of the user mobile device 106. The parameters 104 are representative of attributes of the specific geographic location 110. A presentation component 112 (e.g., of the user mobile device 106) enables viewing 114 of the specific geographic location 110 as presented graphically relative to a virtual geographical map 116 in which the specific geographic location 110 resides, and facilitates navigation back to the specific geographic location 110. The presentation component 112 includes the display system of the device 106, and/or the media systems such as audio, textual, imaging, and so on.

The presentation component 112 can include a user interface that enables configuration of a reminder to capture the attributes of the specific geographic location 110 to facilitate navigation back to the specific geographic location 100. The parameters 104 include at least one of audio information, image information, geolocation information, device communications status information, or motion information, for example. The parameters 104 can also include external information received from external systems related to the specific geographic location. For example, the specific location 110 can include systems that capture and/or store identifying information that can be obtained wirelessly and utilized by the mobile device 106 to guide the user back to the location 110.

The system 100 can further comprise a notification component 118 that enables a user of the user mobile device 106 to initiate self-notification to facilitate recall of the specific geographic location 110 by capturing the attributes of the specific geographic location 110. The system 100 can further comprise a management component that facilitates determination of which parameters 104 are relevant and selected for the specific geographic location 110, and settings for the selected parameters. The detection component 102 includes an application that automatically runs on the user mobile device 106, which can be a mobile phone, to detect the parameters 104.

The specific geographic location 110 can be a parking location of a means of transportation (e.g., car, bus, utility vehicle, bicycle, etc., or simply walking). The detection component 102 detects the parameters and captures attributes associated with parking the means of transportation and the parking location. The presentation component 112 presents the parking location on the virtual map 116, which enables navigation by a user back to the parking location.

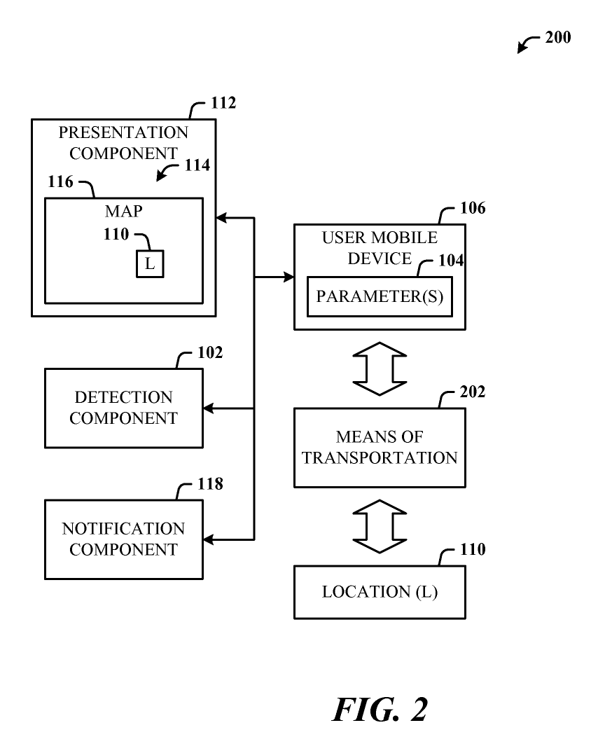

FIG. 2 illustrates a system 200 that enables guidance back to a prior known parking location in accordance with the disclosed architecture. It is to be understood that aspects of the parking implementation are equally applicable to the prior known location, in general. The system 200 includes the detection component 102 that detects the parameters 104 (e.g., geolocation, audio input signals, camera input signals, video input signals, etc.) of the user device 106 (e.g., a mobile device) in association with a means of transportation 202 (e.g., bus, car, truck, train, bicycle, boat, etc.). The parameters 104 are representative of the means of transportation 202 that is assuming a stationary state at the specific geographic location 110. In other words, the parameters 104 can relate to the speed, acceleration/deceleration, dwell (time expended) at a stop (e.g., bus stop, train stop, port, etc.), geolocation data at any point of a route from the point of departure to the destination point. The parameters 104 can include audio signals such as surrounding audio (e.g., alerts, automated voices such as “you are on level 5 space 16”, etc.), at the location 110, leading up to the location 110, after leaving the means of transportation 202 at the location 110, from the means of transportation 202 itself (e.g., “please remove your keys from the ignition and lock your car”), speech from the user, and so on.

The system 200 can also include the presentation component 112 that enables viewing 114 of the specific location 110 as presented graphically relative to the virtual geographical map 116 in which the specific location 110 resides. The means of transportation 202 can be a motorized vehicle parked in the stationary state at the location 110, which is a parking spot in a parking facility. The presentation component 112 can include a user interface that enables configuration of a reminder to establish recall (e.g., make a note of the parking spot location on paper, take photo of location site, look around to commit remarkable structures or features to memory, etc.) of the location 110 and to set to reminders to be displayed when leaving the vehicle is detected.

The parameters 104 can include audio information (e.g., user speech, external audio sounds/signals, means of transportation audio, etc.), image information (e.g., camera photos of the location 110 and surrounding area), geolocation information (GPS (global positioning system) coordinates, triangulation coordinates, etc.), device communications status information (e.g., wireless/wired connect or disconnect from Bluetooth™ system of vehicle, termination of voice call through the vehicle audio system, etc.), and/or motion information (e.g., speed as determined from two geolocation data points, reduction in speed, changes in heading, etc., which indicate the means of transportation may be assuming the stationary state).

The parameters 104 can further or alternatively include external information received from external systems that indicate the user device 106 is assuming the stationary state at the location 110. For example, where the user device 106 has wireless capabilities, information can be uploaded to the user device 106 from a camera system, sensor system, and/or garage/lot management system of a parking garage/lot that provides detailed information as to the location 110, and how to navigate back to the location 110.

The system 200 can further comprise the notification component 118 that enables the user of the user device 106 to initiate self-notification (reminder) to facilitate recall of the location 110. The detection component 102 can include an application that automatically runs on the user device 106, which is a mobile phone. The application detects the parameters 104 that indicate the means of transportation 202 is in the stationary state, which is a parked state.

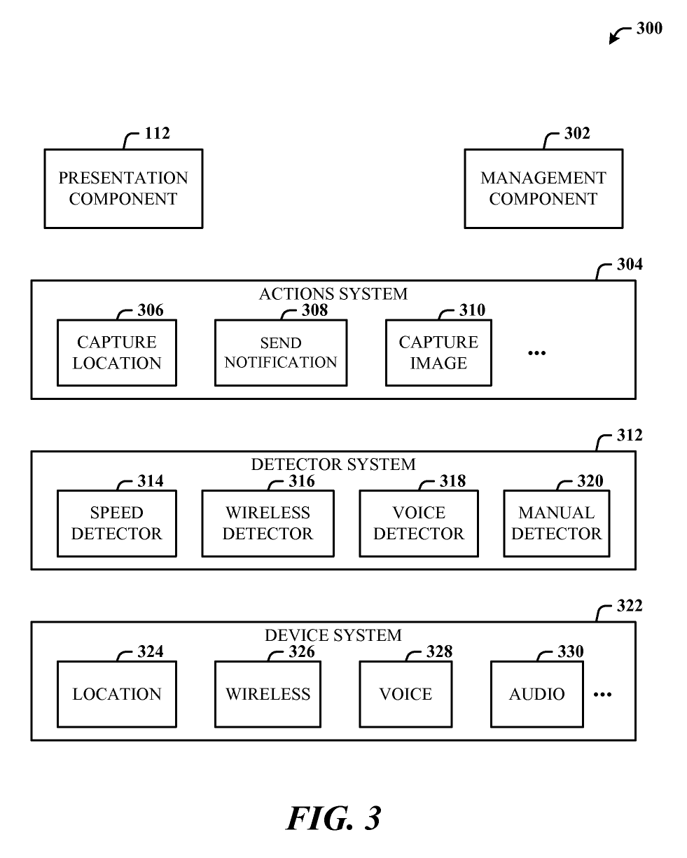

FIG. 3 illustrates an exemplary system 300 for location of a means of transportation or a stop location. The system 300 can include the presentation component 112 (e.g., display, presentation program, etc.) for presenting the location 110 and/or means of transportation. A management component 302 is employed for determining which parameters (detectors and actions) are relevant and selected for the means of transportation (which can be walking), for a given location, and settings for the selected parameters. The management component 302 enables the user to define and configure the detectors that are relevant, configure the noise (e.g., parking) relevant for the means of transportation, and the actions that are to be performed when the means of transportation is in the parked state. This includes setting reminders that are to be displayed.

The system 300 includes an actions system 304, which includes actions that capture the location 306 (e.g., a global capture of images, sound, voice, etc.), send a notification 308, capture an image 310 (e.g., of the location), record audio, and so on.

A notification engine (e.g., the notification component 118) notifies the user when the user leaves the vehicle, as to if the user has set a reminder for that event, for example. An additional feature enables the user to configure reminders that pop-up when the user has left the vehicle (or departs the specific geographic location). The user can also set a reminder to remove something from the vehicle (e.g., pet, child, personal belongings, etc.), turn off lights, etc.

The system 300 also includes a detector system 312 that operates in response to and for the actions of the actions system 304. The detector system 312 can include one or more daemons that run in the background of the user device operating system and detects that the means of transportation is in the stationary state (e.g., parked). The detector system 312 is responsible for detecting that the user (user device) is in a parked state (stationary state).

Each of the detectors of the detector system 312 can indicate that the means of transportation (e.g., car) is in the parked state. A speed detector 314 detects that the user is controlling the means of transportation into a parked state by detection of a change in speed. The speed detector 314 can be an algorithm that processes at least two geo-points (e.g., GPS readings relative to time) to determine speed of the user device (and hence, the means of transportation). The speed detector 314 can be built from a daemon on the user device. The daemon listens to changes in the user's location using the underlying location subsystem 324. When receiving two location events, the speed detector calculates the user's speed. If the user speed is faster than a predefined threshold, the user is considered in a moving state such as walking, driving, riding, etc. When determined to be in a driving state, the speed detector 314 waits to check if the speed has dropped significantly. This can be determined by the absence of location change events or by two consecutive location events which indicate the user speed is slow or stopped, from which can be inferred that the user is considered to be in the parked state.

A wireless detector 316 detects that the means of transportation is in a parked state by detecting that the user device (e.g., mobile phone) has terminated communications (e.g., disconnected) from a predetermined wireless system (e.g., Bluetooth). For example, if the user device is a mobile phone that can connect to a short-range wireless system (e.g., audio system) of the means of transportation, and the user terminates the call, which disconnects the communications, it can be inferred that the user may be preparing to leave the vehicle (in a parked or stationary state) or has left the vehicle.

A voice detector 318 detects that the user has controlled the means of transportation to a parked state by receiving and processing (“listening”) to the automated voice of the locking system (e.g., the voice produced from the vehicle security locking system) or absence of the voice as anticipated when reaching the parked state. The voice detector 318 at least enables the user to record the voice signals produced from a vehicle car when the vehicle is locked. The voice detector 318 uses the device microphone and waits to hear predefined voice signals (e.g., as previously input and stored for later comparison). Once received and processed, the vehicle is considered in the stationary state.

A manual detector 320 detects that the user has input information that the means of transportation is now in the stationary (parked) state. Thus, this detector 320 enables the user to proactively input that the vehicle is in the parked state.

A device system 322 includes the hardware and software for running and operating the subsystems of the user device, such as a location subsystem 324 (e.g., GPS) for determining and processing geolocation information, a wireless subsystem 326 for wireless communications, a voice subsystem 328 for speech input and processing, an audio subsystem 330 for recording sounds, and so on.

The detector system 312 can use a combination of the following methods to perform the detection. The user has modified transport speed from high speed to zero, and then moved to a very slow speed. This indicates the user may have switched from driving to walking. This detection can be performed using the device GPS subsystem. In combination therewith, the user has disconnected from a predefined short-range wireless (e.g., Bluetooth) hands-free system of the vehicle. Additionally, the audio signals of the vehicle locking (e.g., from the car remote security system) was sensed by the user device microphone.

When the user wants to find the user vehicle, the user accesses the user device and views the vehicle location as displayed on the map, for example. However, in many places parking lots extend into underground areas, and thus, reading the current user location may be problematic when using look-down geo-location systems such as GPS. The disclosed architecture takes this into consideration by enabling full utilization of onboard systems of the user device, and optionally external systems. For example, a camera system can be used to take photos. Additionally, indoor location techniques such as access point provisioning or registration, IP addresses, etc., can be used to estimate user location and for determining where the vehicle was parked.

Put another way, a system is provided that comprises a detection component that detects parameters of a mobile device suitable for identifying in association with a vehicle, if the vehicle is assuming or in a parked state at a parking location, a notification component that enables a user of the mobile device to set a reminder to facilitate recall of the parking location of the vehicle, and a presentation component that enables viewing of the parking location of the vehicle as presented graphically relative to a virtual map in which the parking location is located. The system can further comprise a management component enables selection of one or more of the parameters which are relevant for the vehicle and the parking location, and settings of the selected parameters.

The detection component includes an application that runs in a background environment of an operating system of the mobile device to automatically receive parameter data which when processed indicates the vehicle is in the parked state. The parameters can include at least one of audio information associated with mechanical sounds and an audio profile of the vehicle, image information associated with a camera shot of a scene of the parking location, or geolocation information associated with geographical coordinates of the parking location. The parameters can include at least one of device communications status information related to disconnect of the mobile device from communication with a subsystem of the vehicle, or motion information related to deceleration of the vehicle and dwell time of the vehicle at the parking location.

In a more generalized implementation of navigation to a prior known location, a computer-implemented system is provide that comprises a detection component of a mobile device that detects parameters of the mobile device suitable for capturing attributes of a specific geographic location, a notification component that enables a user of the mobile device to set a reminder to enable capture of the attributes at the specific geographic location when the user is detected to be leaving the specific geographic location, and a presentation component that enables viewing of the specific geographic location as presented graphically relative to a virtual map in which the specific geographic location is located.

The system further comprises a management component enables selection of one or more of the parameters which are relevant to specific geographic location, and settings of the selected parameters. The detection component includes an application that runs in a background environment of an operating system of the mobile device to automatically receive attribute data which when processed is associated with the specific geographic location and facilitate navigation back thereto.

The parameters can be related to and include at least one of audio information associated with mechanical sounds and an audio profile of a vehicle at the specific geographic location, image information associated with a camera shot of a scene at the specific geographic location, or geolocation information associated with geographical coordinates of the specific geographic location. The parameters can include at least one of device communications status information of the mobile device at the specific geographic location, or motion information related to dwell time of the mobile device at the specific geographic location.

The disclosed architecture has been described in the context of using device systems to remind and find a prior known location and a previously parked vehicle. However, the architecture finds application as well to stops the user has made with or without a vehicle. For example, if the user is hiking and stops to rest, and then heads off in a different direction, the architecture can be utilized to issue a reminder and/or capture information related to the stop so that the user can backtrack if lost, or is simply returning the same way. A stop can be identified and returned to as a place at which food or gear was cached during a hike.

This architecture can be applied as well to stops in a city when using a subway system or other public transportation such that over multiple stops, it can be confusing as to where the user should get off. At the desired stop, information can be captured and stored for the return trip so the user can get off at the desired stop.

In yet another example, coastal shorelines can be confusing to navigate and to use as means to navigate waterways. One of the big problems with boating in large lakes or bodies of water in the wilderness is the lack of discernable landmarks from which to navigate, when using personal water craft, canoeing, hiking, etc. The shoreline is predominantly trees and bushes—no buildings exist or are visible in these sparsely populated areas. For example, in the Boundary Waters area of Northern Minnesota, the lake system is used by recreational canoers and campers, who must be very careful to track where they are, where they are going, and where they have gone in an endless maze of islands and lakes. People hiking and canoeing in this area need to login and logout, such that if the logout date is missed, a rescue team is then sent to search for the missing persons.

The disclosed architecture enables a user to periodically stop along the shoreline and “tag” or “bookmark” a location along the shoreline as a way of “laying bread crumbs” in order to get navigate back out of these wilderness places. This applies to hiking as well. In an alternative implementation, geo-fencing can be implemented as a means of alerting the user while on the lake or a hiking trail that they are near a tagged (prior known) location, and on the right path to navigating back to an initial (known) location. In other words, the user can establish stops along the shoreline that when detected within a specified distance, enable the user to see the stop on a map as a way to reaffirm navigation along the shoreline.

In yet another implementation, the disclosed system is installed as part of the user vehicle such that the desired information is collected by the vehicle systems and then uploaded to the user device when stopped and exiting the vehicle.

In all embodiments described herein, the tagging or bookmarking of the location so as to enable user navigation back can be performed manually and/or automatically. Moreover, automatic tagging or bookmarking of locations can be performed as described herein, continuously, according to some predetermined data acquisition time, or a combination of any of the previously mentioned.

For example, when using a continuous (data collection) mode, the user device automatically collects data at all times, or according to an automatic trigger at the location to then initiate storage or save of the collected information (at that time), in association with the location. No user interaction is used.

In a manual mode, once the user determines that the location is to be tagged or marked for navigation back thereto, the user can then manually trigger the user device to begin and complete operations to capture as much data as deemed relevant for the location, and then to store the information for use in returning.

In a third mode (a combination of continuous mode and manual mode), the user device automatically collects data at all times, and all the user needs to do is to interact with the user device (e.g., press a button, voice a command, input a code, etc.) at the location to then manually initiate (trigger) storage or save of the collected information (at that time), in association with tagging or marking the location.

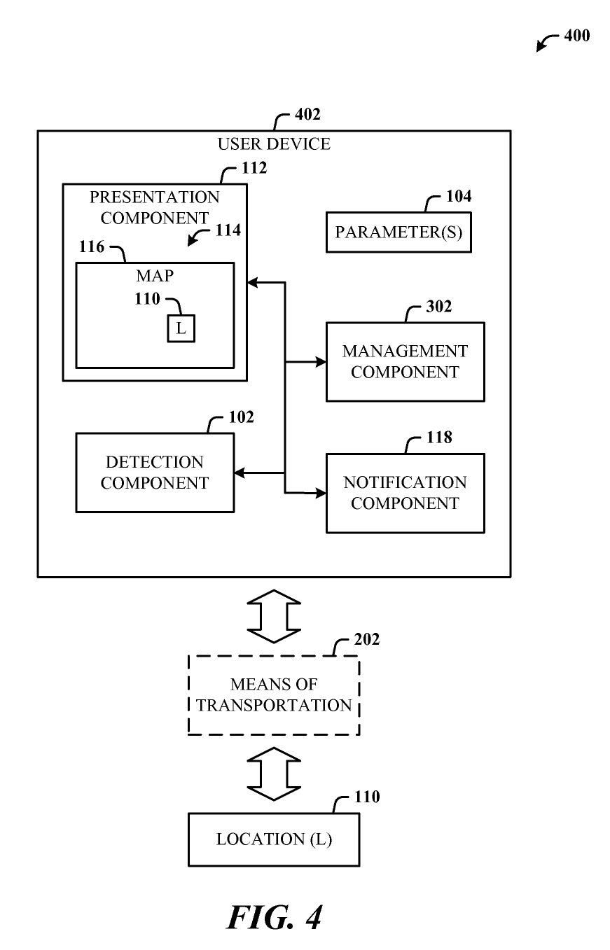

FIG. 4 illustrates an exemplary system 400 where the user device 402 (e.g., a mobile phone, mobile-capable portable computer, etc.) includes the presentation component 112, detection component 102, notification component 118, and the management component 302. The means of transportation 202 is optional since the location 110 need not be arrived at or related to transportation at all.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

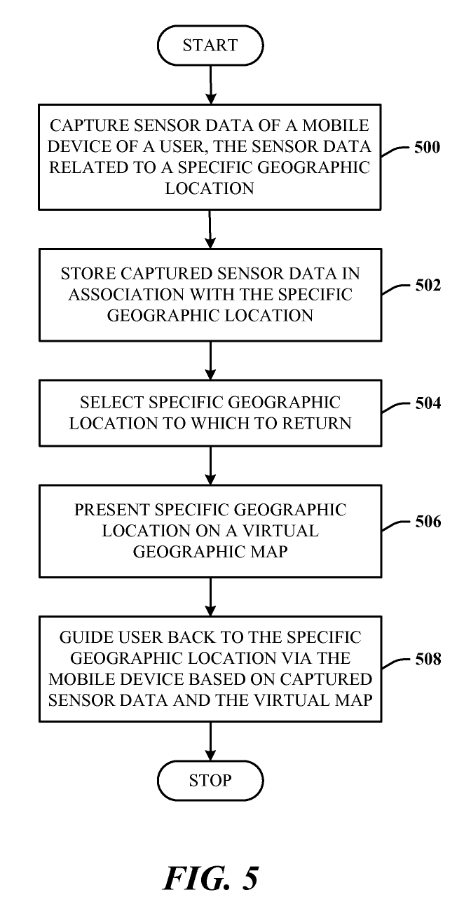

FIG. 5 illustrates a method in accordance with the disclosed architecture. At 500, sensor data of a mobile device of a user is captured. The sensor data is related to a specific geographic location. At 502, the captured sensor data is stored in association with the specific geographic location. At 504, the specific geographic location is selected to which to return. At 506, the specific geographic location is presented on a virtual geographic map. At 508, the user is guided back to the specific geographic location via the mobile device based on captured sensor data and the virtual map.

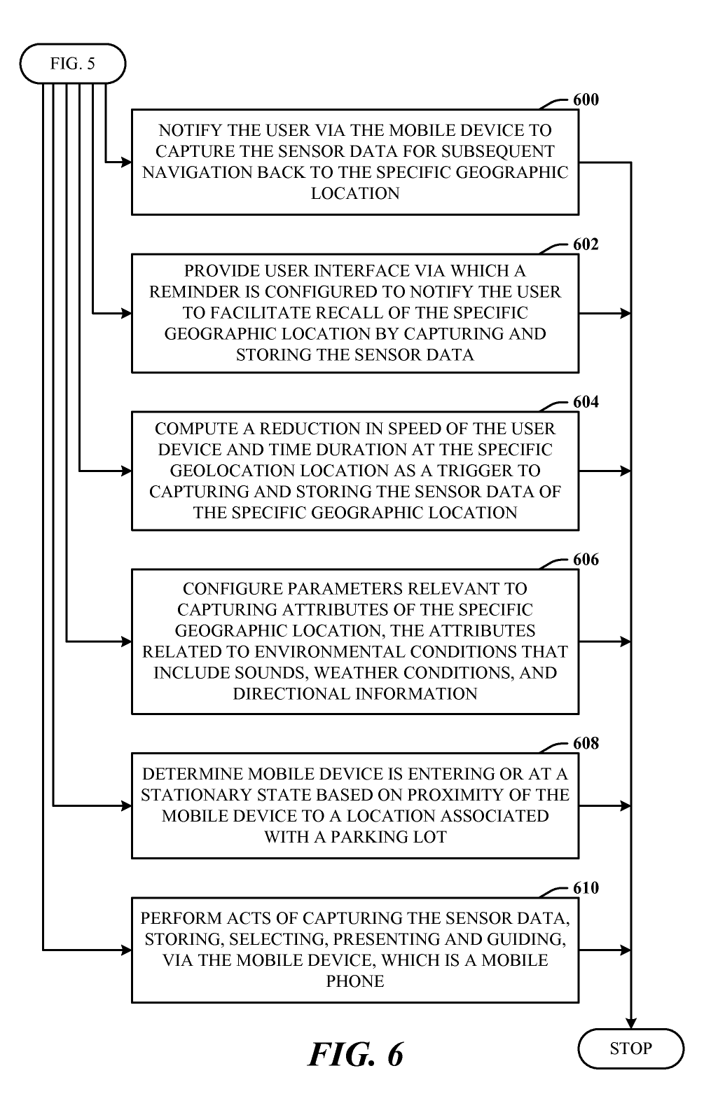

FIG. 6 illustrates further aspects of the method of FIG. 5. Note that the flow indicates that each block can represent a step that can be included, separately or in combination with other blocks, as additional aspects of the method represented by the flow chart of FIG. 5. At 600, the user via the mobile device is notified to capture the sensor data for subsequent navigation back to the specific geographic location. At 602, a user interface is provided via which a reminder is configured to notify the user to facilitate recall of the specific geographic location by capturing and storing the sensor data. At 604, a reduction in speed of the user device and time duration is computed at the specific geolocation location as a trigger to capturing and storing the sensor data of the specific geographic location. At 606, parameters are configured relevant to capturing attributes of the specific geographic location. The attributes can be related to environmental conditions that include sounds, weather conditions, and directional information. At 608, the mobile device is determined to be entering or at a stationary state based on proximity of the mobile device to a location associated with a parking lot. At 610, the acts of capturing the sensor data, storing, selecting, presenting, and guiding are performed via the mobile device, which is a mobile phone.

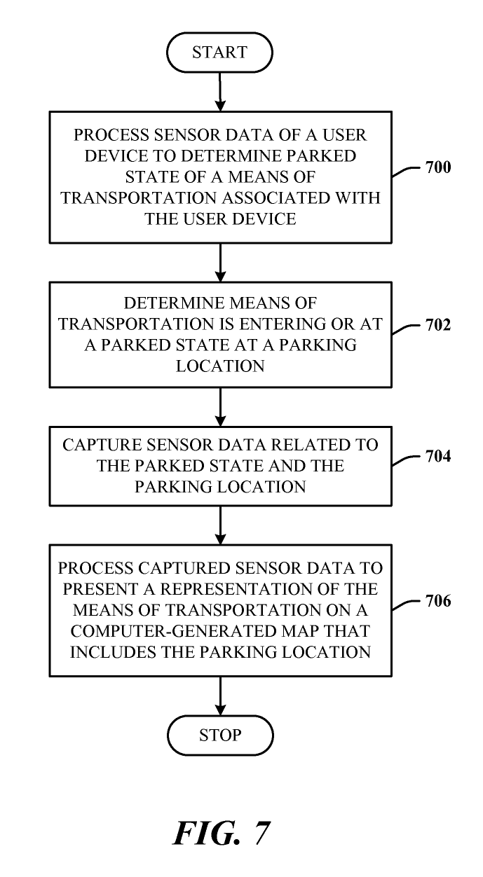

FIG. 7 illustrates an alternative method in accordance with the disclosed architecture. At 700, sensor data of a user device is processed to determine parked state of a means of transportation associated with the user device. At 702, the means of transportation is determined to be entering or at a parked state at a parking location. At 704, sensor data related to the parked state and the parking location is captured. At 706, the captured sensor data is processed to present a representation of the means of transportation on a computer-generated map that includes the parking location.

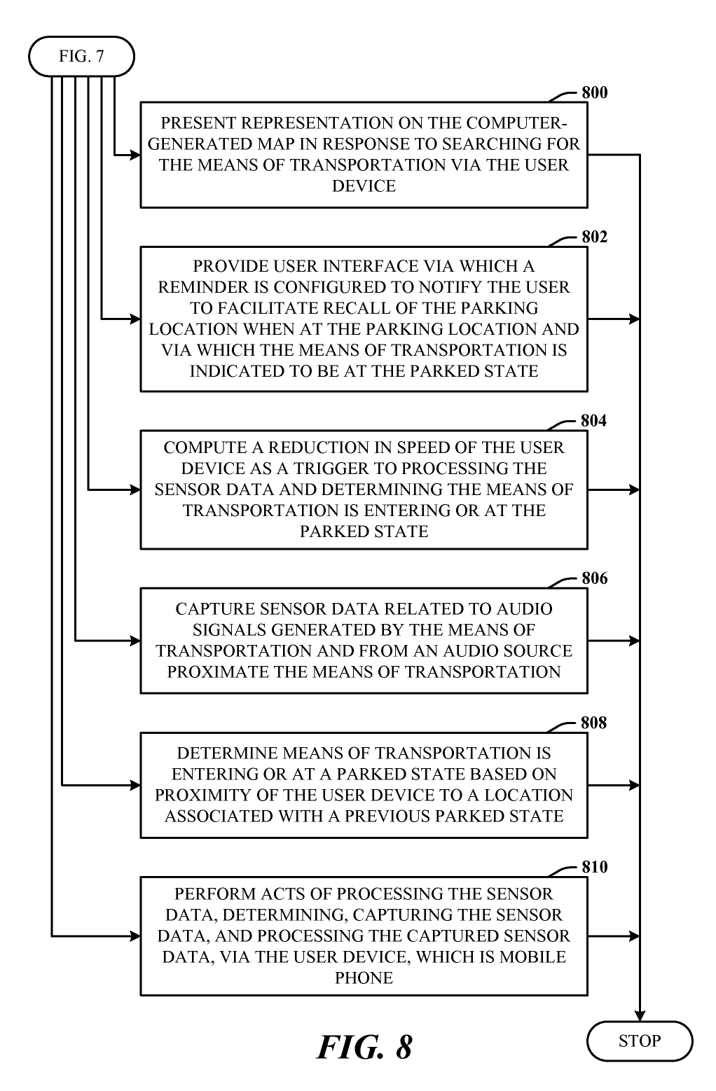

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, the representation is presented on the computer-generated map in response to searching for the means of transportation via the user device. At 802, a user interface is provided via which a reminder is configured to notify the user to facilitate recall of the parking location when at the parking location and via which the means of transportation is indicated to be at the parked state. At 804, a reduction in speed of the user device is computed as a trigger to processing the sensor data and determining the means of transportation is entering or at the parked state. At 806, sensor data related to audio signals generated by the means of transportation and from an audio source proximate the means of transportation is captured. At 808, the means of transportation is determined to be entering or at a parked state based on proximity of the user device to a location associated with a previous parked state. At 810, the acts of processing the sensor data, determining, capturing sensor data, and processing the captured sensor data, are performed via the user device, which is mobile phone.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

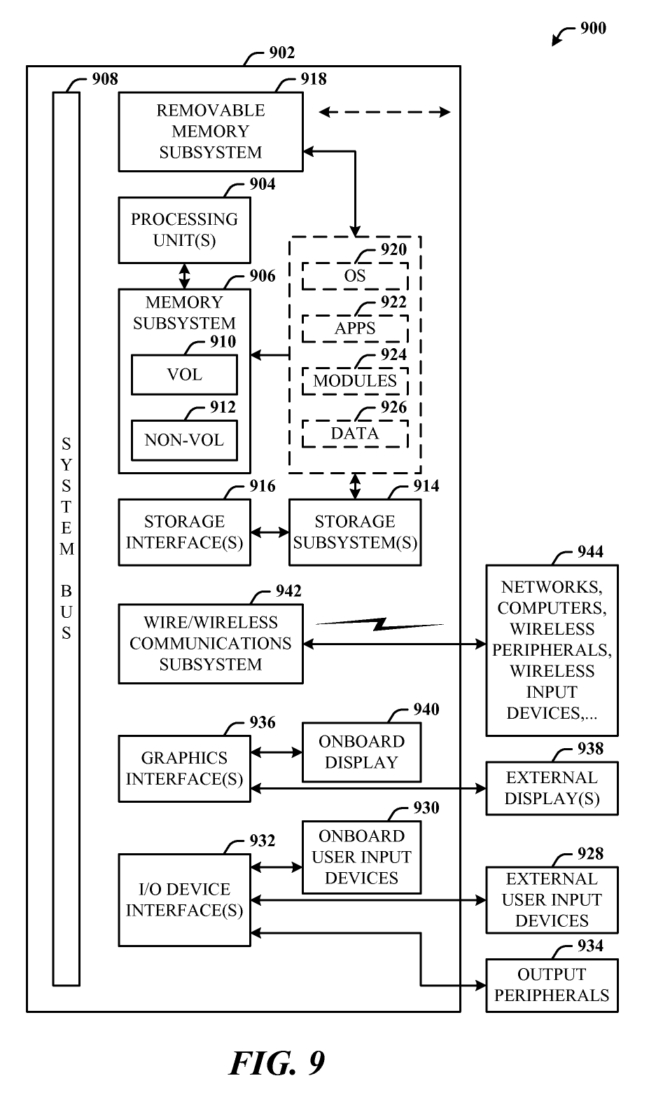

Referring now to FIG. 9, there is illustrated a block diagram of a computing system 900 that executes location architecture in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a computer-readable storage such as a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include computer-readable storage (physical storage media) such as a volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 (physical storage media) can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include entities and components of the system 100 of FIG. 1, entities and components of the system 200 of FIG. 2, entities and components of the system 300 of FIG. 3, entities and components of the system 400 of FIG. 4, and the methods represented by the flowcharts of FIGS. 5-8, for example.

Similarly, a mobile device (e.g., mobile phone) can be employed where its operating system, one or more application programs, other program modules, and/or program data can include entities and components of the system 100 of FIG. 1, entities and components of the system 200 of FIG. 2, entities and components of the system 300 of FIG. 3, entities and components of the system 400 of FIG. 4, and the methods represented by the flowcharts of FIGS. 5-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 902 and includes volatile and non-volatile internal and/or external media that is removable or non-removable. For the computer 902, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices, or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system, comprising:
a detection component of a user mobile device that detects parameters associated with a specific geographic location of the user mobile device, the parameters representative of attributes of the geographic location;
a presentation component of the user mobile device that enables viewing of the specific geographic location as presented graphically relative to a virtual geographical map in which the specific geographic location resides and facilitates navigation back to the specific geographic location; and
a processor that executes computer-executable instructions associated with at least one of the detection component or the presentation component.

2. The system of claim 1, wherein the presentation component includes a user interface that enables configuration of a reminder to capture the attributes of the specific geographic location to facilitate navigation back to the specific geographic location.

3. The system of claim 1, wherein the parameters include at least one of audio information, image information, geolocation information, device communications status information, or motion information.

4. The system of claim 1, wherein the parameters include external information received from external systems related to the specific geographic location.

5. The system of claim 1, further comprising a notification component that enables a user of the user mobile device to initiate self-notification to facilitate recall of the specific geographic location by capturing the attributes of the specific geographic location.

6. The system of claim 1, further comprising a management component that facilitates determination of which parameters are relevant and selected for the specific geographic location, and settings for the selected parameters.

7. The system of claim 1, wherein the detection component includes an application that automatically runs on the user mobile device, which is a mobile phone, to detect the parameters.

8. The system of claim 1, wherein the specific geographic location is a parking location of a means of transportation, the detection component detects parameters and captures attributes associated with parking the means of transportation and the parking location, the presentation component presents the parking location on the virtual map, which enables navigation of a user back to the parking location.

9. A computer-implemented system, comprising:
a detection component of a mobile device that detects parameters of the mobile device suitable for capturing attributes of a specific geographic location;
a notification component that enables a user of the mobile device to set a reminder to enable capture of the attributes at the specific geographic location when the user is detected to be leaving the specific geographic location;
a presentation component that enables viewing of the specific geographic location as presented graphically relative to a virtual map in which the specific geographic location is located; and
a processor that executes computer-executable instructions associated with at least one of the detection component, notification component, or the presentation component.

10. The system of claim 9, further comprising a management component enables selection of one or more of the parameters which are relevant to specific geographic location, and settings of the selected parameters.

11. The system of claim 9, wherein the detection component includes an application that runs in a background environment of an operating system of the mobile device to automatically receive attribute data which when processed is associated with the specific geographic location and facilitate navigation back thereto.

12. The system of claim 9, wherein the parameters are related to and include at least one of audio information associated with mechanical sounds and an audio profile of a vehicle at the specific geographic location, image information associated with a camera shot of a scene at the specific geographic location, or geolocation information associated with geographical coordinates of the specific geographic location.

13. The system of claim 9, wherein the parameters include at least one of device communications status information of the mobile device at the specific geographic location, or motion information related to dwell time of the mobile device at the specific geographic location.

14. A computer-implemented method, comprising acts of:
capturing sensor data of a mobile device of a user, the sensor data related to a specific geographic location;
storing the captured sensor data in association with the specific geographic location;
selecting the specific geographic location to which to return;
presenting the specific geographic location on a virtual geographic map;
guiding the user back to the specific geographic location via the mobile device based on captured sensor data and the virtual map; and
utilizing a processor that executes instructions stored in memory to perform at least one of the acts of capturing, storing, selecting, presenting, or guiding.

15. The method of claim 14, further comprising notifying the user via the mobile device to capture the sensor data for subsequent navigation back to the specific geographic location.

16. The method of claim 14, further comprising providing a user interface via which a reminder is configured to notify the user to facilitate recall of the specific geographic location by capturing and storing the sensor data.

17. The method of claim 14, further comprising computing a reduction in speed of the user device and time duration at the specific geolocation location as a trigger to capturing and storing the sensor data of the specific geographic location.

18. The method of claim 14, further comprising configuring parameters relevant to capturing attributes of the specific geographic location, the attributes related to environmental conditions that include sounds, weather conditions, and directional information.

19. The method of claim 14, further comprising determining the mobile device is entering or at a stationary state based on proximity of the mobile device to a location associated with a parking lot.

20. The method of claim 14, further comprising performing the acts of capturing the sensor data, storing, selecting, presenting and guiding, via the mobile device, which is a mobile phone.
